(19) United States
(12) Patent Application Publication
(10) Pub. No.: US 2022/0107141 A1
(43) Pub. Date: Apr. 7, 2022

(54) LARGE CAPACITY HEAT SINK VESSEL FOR THERMAL ENERGY STORAGE

(71) Applicant: Aestus Energy Storage, LLC, Pittsford, NY (US)

(72) Inventor: Thomas Wagner, Troy, NY (US)

(21) Appl. No.: 17/495,698

(22) Filed: Oct. 6, 2021

Related U.S. Application Data
(60) Provisional application No. 63/087,999, filed on Oct. 6, 2020.

(51) Int. Cl. F28D 20/00

(52) U.S. Cl. CPC F28D 20/0056; F28D 2020/0078; F28D 2020/0069

(57) ABSTRACT

Heat sink vessels are disclosed. The heat sink vessel includes a body defining an interior volume that circulate a working fluid therethrough. The body includes a first guidance portion coupled to a first port, a second guidance portion coupled to a second port and a middle portion coupled to the first and second guidance portions. The middle portion includes a heat sink core. The heat sink core is formed from a plurality of heat sink modules collectively arranged and coupled together to form a plurality of flow passages through the heat sink core. The heat sink vessel is configured to circulate the working fluid through the plurality of flow passages of the heat sink core via the first port and the second port.

### TECHNICAL FIELD

The present disclosure generally relates to high capacity energy storage and, more particularly, to an improved heat sink vessel design including a heat sink core formed of heat sink elements in at least one modular array, thereby enabling multiple storage structures for large capacity thermal energy storage.

### BACKGROUND

Energy storage is utilized in multiple applications on a global basis. Non-limiting examples of such applications include storage of variable renewable power to align with load demand, management of demand charges in congested markets, support of transmission and distribution grid robustness, enabling microgrid applications and providing charging sources for electric vehicle operation. Many of the storage applications may be supported by chemical and flow batteries. Systems that are supported by chemical and/or flow batteries, however, generally have limited lifecycles and limited discharge support times.

There is a need for improved thermal energy storage for renewable energy sources.

### SUMMARY

Aspects of the present disclosure relate to heat sink vessels. A heat sink vessel includes a body defining an interior volume. The body is configured to circulate a working fluid therethrough. The body includes a first guidance portion coupled to a first port, a second guidance portion coupled to a second port and a middle portion coupled to each of the first guidance portion and the second guidance portion. The middle portion includes a heat sink core. The heat sink core is formed from a plurality of heat sink modules collectively arranged and coupled together to form a plurality of flow passages through the heat sink core. The heat sink vessel is configured to circulate the working fluid through the plurality of flow passages of the heat sink core via the first port and the second port.

Aspects of the present disclosure also relate to heat sink vessels adapted for a horizontal configuration. The heat sink vessel includes a body defining an interior volume. The body is configured to circulate a working fluid therethrough. The body includes a first guidance portion coupled to a first port, a second guidance portion coupled to a second port, a middle portion coupled to each of the first guidance portion and the second guidance portion, and at least one support structure. The middle portion includes a heat sink core. The heat sink core is formed from a plurality of heat sink modules collectively arranged and coupled together to form a plurality of flow passages through the heat sink core. The heat sink vessel is configured to circulate the working fluid through the plurality of flow passages of the heat sink core via the first port and the second port. The plurality of flow passages arranged to extend in a horizontal configuration. The at least one support structure is disposed in at least one of the first guidance portion and the second guidance portion. The at least one support structure is configured to restrain the heat sink core in the horizontal configuration.

Aspects of the present invention also relate to heat sink vessels for a vertical configuration. A heat sink vessel includes a body defining an interior volume. The body is configured to circulate a working fluid therethrough. The body includes a first guidance portion coupled to a first port at a bottom portion of the body, a second guidance portion coupled to a second port at an upper portion of the body, a middle portion coupled to each of the first guidance portion and the second guidance portion and a support structure. The middle portion includes a heat sink core. The heat sink core is formed from a plurality of heat sink modules arranged in at least one array and coupled together to form a plurality of flow passages through the heat sink core. The heat sink vessel is configured to circulate the working fluid through the plurality of flow passages of the heat sink core via the first port and the second port. The plurality of flow passages are arranged to extend in a vertical configuration. The support structure is disposed in the bottom portion of the body and is configured to support the heat sink core.

### BRIEF DESCRIPTION OF THE DRAWINGS

The present disclosure may be understood from the following detailed description when read in connection with the accompanying drawings. It is emphasized that, according to common practice, various features of the drawings may not be drawn to scale. On the contrary, the dimensions of the various features may be arbitrarily expanded or reduced for clarity. Moreover, in the drawings, common numerical references are used to represent like features. Included in the drawing are the following figures:

FIG. 1A is a perspective view diagram of an example heat sink vessel, according to an aspect of the present disclosure.

FIG. 1B is a detail view diagram of the heat sink vessel shown in FIG. 1A illustrating detail portion 1B, according to an aspect of the present disclosure.

FIG. 1C is a cross-sectional view diagram of the heat sink vessel shown in FIG. 1A along line 1C-1C, according to an aspect of the present disclosure.

FIG. 1D is a perspective view diagram of the heat sink vessel shown in FIG. 1C along line 1D-1D, according to an aspect of the present disclosure.

FIG. 1E is a perspective view diagram of an example flow distribution and acceleration device of the heat sink vessel shown in FIG. 1D, according to an aspect of the present disclosure.

FIG. 2A is a front perspective view diagram of an example heat sink module, according to an aspect of the present disclosure.

FIG. 2B is aback perspective view diagram of an example heat sink module, according to an aspect of the present disclosure.

FIG. 2C is an exploded perspective view diagram of the heat sink module shown in FIG. 2A, according to an aspect of the present disclosure.

FIG. 2D is a front view diagram of the heat sink module shown in FIG. 2A, according to an aspect of the present disclosure.

FIG. 2E is across-sectional view diagram of the heat sink module shown in FIG. 2D along line 2E-2E, according to an aspect of the present disclosure.

FIG. 3A is a cross-sectional perspective view diagram of an example heat sink vessel illustrating an example horizontal configuration, according to aspect of the present disclosure.

FIG. 3B is a detail view diagram of the heat sink vessel shown in FIG. 3A illustrating detail portion 3B, according to an aspect of the present disclosure.

FIG. 3C is a cross-sectional view diagram of the heat sink vessel shown in FIG. 3A, according to an aspect of the present disclosure.

FIG. 3D is a detail view diagram of the heat sink vessel shown in FIG. 3C illustrating detail portion 3D, according to an aspect of the present disclosure.

FIG. 4A is a cross-sectional perspective view diagram of a portion of the heat sink vessel shown in FIG. 3A along line 4A-4A, according to an aspect of the present disclosure.

FIG. 4B is a perspective view diagram of a portion of a heat sink core shown in FIG. 4A, according to an aspect of the present disclosure.

FIG. 4C is a front view diagram of a portion of the heat sink core shown in FIG. 4A, according to an aspect of the present disclosure.

FIG. 4D is a cross-sectional perspective view diagram of a portion of the heat sink core shown in FIG. 4A along line 4D-4D, according to an aspect of the present disclosure.

FIG. 5A is a cross-sectional perspective view diagram of a portion of the heat sink vessel shown in FIG. 3C along line 5A-5A, according to an aspect of the present disclosure.

FIG. 5B is a cross-sectional perspective view diagram of a portion of the heat sink vessel shown in FIG. 5A along line 5B-5B, according to an aspect of the present disclosure.

FIG. 5C is a perspective view diagram of an example arch support of the heat sink vessel shown in FIG. 5B, according to an aspect of the present disclosure.

FIG. 5D is a perspective view diagram of a portion of the heat sink vessel shown in FIG. 5B along line 5D-5D, according to an aspect of the present disclosure.

FIG. 5E is a detail view diagram of the heat sink vessel shown in FIG. 5D illustrating detail portion 5E, according to aspect of the present disclosure.

FIGS. 6A, 6B and 6C are perspective view diagrams of example heat sink modules, according to aspects of the present disclosure.

FIG. 6D is an exploded perspective view diagram of the example heat sink module shown in FIG. 6A, according to an aspect of the present disclosure.

FIG. 6E is an exploded perspective view diagram of a portion of a heat sink vessel illustrating a configuration of heat sink modules in a heat sink core, according to an aspect of the present disclosure.

FIG. 6F is a cross-sectional perspective view diagram of a portion of the heat sink core shown in FIG. 6E along line 6F-6F, according to an aspect of the present disclosure.

FIG. 7A is a perspective view diagram of an example heat sink vessel illustrating a vertical configuration, according to an aspect of the present disclosure.

FIG. 7B is a cross-sectional perspective view diagram of the heat sink vessel shown in FIG. 7A along line 7B-7B, according to an aspect of the present disclosure.

FIG. 7C is a detail view diagram of the heat sink vessel shown in FIG. 7B illustrating detail view 7C, according to an aspect of the present disclosure.

FIG. 7D is a detail view diagram of the heat sink vessel shown in FIG. 7B illustrating detail view 7D, according to an aspect of the present disclosure.

FIG. 8A is a perspective view diagram of a portion of a heat sink core of the heat sink vessel shown in FIG. 7B, according to an aspect of the present disclosure.

FIG. 8B is an exploded perspective view of the heat sink core portion shown in FIG. 8A, according to an aspect of the present disclosure.

FIG. 8C is a detail view diagram of the heat sink core portion shown in FIG. 8B illustrating detail view 8C, according to an aspect of the present disclosure.

FIG. 8D is an exploded perspective view of the heat sink core portion shown in FIG. 8A, according to another aspect of the present disclosure.

FIG. 8E is a detail view diagram of the heat sink core portion shown in FIG. 8D illustrating detail view 8E, according to an aspect of the present disclosure.

### DETAILED DESCRIPTION

As discussed above, conventional energy storage systems typically have limited lifecycles and limited discharge support times. In contrast, thermal energy systems of the present disclosure relate to a high capacity energy storage solution (e.g., including a storage capacity for about the 100 MW class and greater) and more particularly to an improved heat sink vessel design. In an example embodiment, a heat sink vessel of the present disclosure may enable multiples of 100 MW-h storage in a modular array of heat sink modules. In some examples, thermal energy storage systems of the present disclosure may be configured to include a life that may exceed 20 years and may provide discharge durations that can achieve about 10 to 14 hours, with a capacity to enable storage of energy in multiples of about 100 MW-h. As such, systems of the present disclosure can economically support long load demand cycles, without extensive maintenance and/or replacement.

In some examples, aspects of the present disclosure include a heat sink vessel within a system that may be modularly configured to store multiples of about 100 MW-h of thermal energy. This energy can be stored, in the heat sink vessel, when power is available and may be released to meet load demands. The heat sink vessel of the present disclosure may be configured to allow for standard shipping and on-site assembly using standard millwright labor and tooling.

In some examples, aspects of the present disclosure relate to a heat sink and containment vessel. The heat sink and containment vessel may be configured to store multiples of about 100 MW-h of energy in a modular configuration. In some examples, elements of the heat sink and vessel may be designed to allow shipment within a standard shipping envelope and/or container, and may be fabricated in a factory and modularly assembled at the operation site. In some examples, the vessel may be fabricated from carbon steel and assembled by gasketed, bolted flanges. For applications that place the vessel underground, the surface may be coated, in some examples, with corrosion inhibiting coating. In some examples, the vessel may be insulated with an alumina-silica blanket and fiber to maintain the carbon steel shell at a temperature that is less than about 100° C. In some example, the heat sink media may be formed from a material such as an alumina-silicate ceramic like cordierite or alumina. In some examples, the heat sink media may be packaged in a hexagonal array. In some examples, the heat sink media may be supported by an andalusite alumina silica or alumina silica brick shell. In some examples, the heat sink media may be stacked to build the heat sink core. The heat sink core and support layer may be selected, in some examples, to have similar coefficients of thermal expansion. The heat sink core and alumina may be configured to allow differential thermal movement of the core and shell. In some examples, an inlet to the heat sink media may be shaped to guide and distribute the flow of an inert working fluid uniformly thru the heat sink core. In some examples, a flow distributor may also be used at the inlet of the heat sink to distribute flow of the working fluid. The overall core stack and insulation may be configured, in some examples, to manage heat loss to a low level.

In some examples, containment of the heat sink of the present disclosure may be provided by carbon steel (e.g., a low cost material). In some examples, the heat sink may be enclosed within a carbon steel shell and an insulation system. In some examples, the insulation system may use one or more materials commonly used in refractory applications. In some examples, the insulation system may include a thermal blanket (e.g., a ceramic paper) that wraps a fiber board to enclose one or more heat sink modules. In some examples, an insulation configuration may include predominantly alumina-silicate. In some examples, characteristics of the insulation configuration may be selected to closely match a thermal expansion coefficient of the heat sink core.

In some examples, the heat sink may be configured from one or more ceramic elements that may allow an inert working fluid to pass through the core to deposit or remove heat. Each heat sink module may be formed from several elements stacked to allow a straight flow passage. In some examples, the heat sink modules may be encapsulated by a shell formed from a material such as (but not limited to andalusite or alumina silica). The shell may provide containment and/or structural support of the heat sink elements.

In some examples, each heat sink module may be stacked in a hexagonal array and interconnected to provide an impervious boundary, to assure all flow is through the heat sink elements. In some examples, each array may be positioned (for example, with lifting tooling) and connected to the insulation system and other modules at an application site.

In some examples, the heat sink modules facing a flow direction may include contouring of the (e.g., andalusite or brick) boundaries to direct flow into the heat sink elements and to support a face of the heat sink during operation. In some examples, heat sink modules at the back of the array may include a similar contouring, to allow flow to exit without creating excessive back pressure.

In some examples, the insulation systems of the present disclosure may be configured to hold the thermal energy in place and manage losses to about 1% or less in a twenty four hour period.

In some examples, a series of cones may be positioned at both an inlet and an outlet of the heat sink vessel of the present disclosure, to distribute the inlet flow and accelerate the outlet flow, respectively.

In some embodiments, a heat sink vessel of the present disclosure may be configured for operation in a horizontal arrangement. In some examples, a heat sink of the present disclosure may be configured for operation in a vertical arrangement. In some examples, a horizontal configuration may include gaps in elements of the heat sink core, to allow for the movement of the heat sink core during operation. In some examples, a vertical configuration may include an arch structure to restrain the heat sink. In some examples, gaps may not be utilized in the vertical configuration, to permit the heat sink core to expand and return to a start position under a gravity load.

In some examples, aspects of the heat sink vessel of the present disclosure may include the use of a flanged, gasketed carbon steel shell to support shipment, site assembly and containment of the heat sink under pressure. In addition, the heat sink vessel may utilize modular heat sinks to support shipment, site assembly and control tolerance, alignment of heat sink passages. Aspects of the heat sink vessel further include the use of a modular structure of an out shell, an insulation system, and a heat sink core. In some examples, the vessel may utilize andalusite to create heat sink modules and transfer a load to the base/foundation of the heat sink. In some examples, the heat sink vessel may utilize a contour shape of inlet and outlet of heat sink for flow guidance and distribution. In some examples, the heat sink vessel may utilize a concentric cone structure to distribute inlet flow and accelerate outlet flow, to manage a pressure drop of an energy storage system. In some examples, the heat sink vessel may include an inlet and/or outlet support to restrain a face of the heat sink (e.g., in a horizontal configuration). In some examples, the heat sink vessel may include an arch to support the heat sink and direct flow (e.g., in a vertical configuration).

In general, a life and capacity of a heat sink vessel may be a function of the inert working fluid and the mechanical design to allow thermal movement of the design. When an oxidizing environment is removed by inert working fluid heat transfer, the life of the refractory material may be extended. Secondly, by managing the thermal expansion of the heat sink, the loads on the heat sink may be reduced to very low levels and a typical failure mode may be eliminated. These two actions may enable a long heat sink life. The achievement of 100 MW-h of storage by heat sink vessels of the present disclosure may be based in part, on packaging a suitable of a (e.g., ceramic) heat sink (via the array of heat sink modules) and designing the vessel for fluid flow and heat transfer suitable to store at least about 100 MW-h of thermal energy and later retrieve that energy via one or more charging an discharging cycles. A novel of aspect of heat sink vessels of the present disclosure includes the use of modular sections of a refractory (i.e., the heat sink core). The vessel may also be formed (i.e., built up) via a stacking technique. Another novel aspect includes the shaping of the refractory (the heat sink core) to form arch supports and interface with conical inlets/outlet to support the movement of the heat sink in a horizontal configuration.

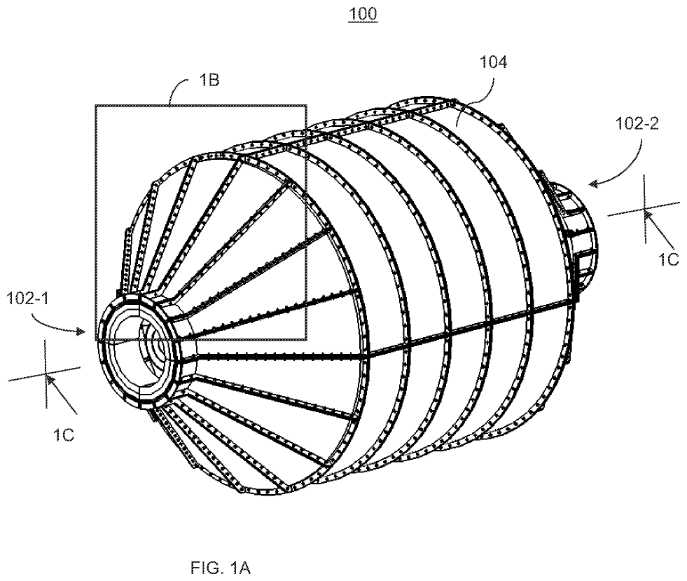

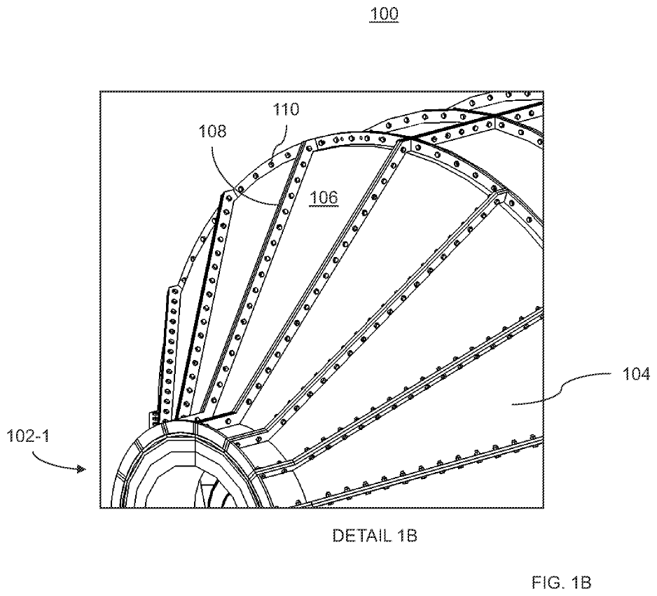

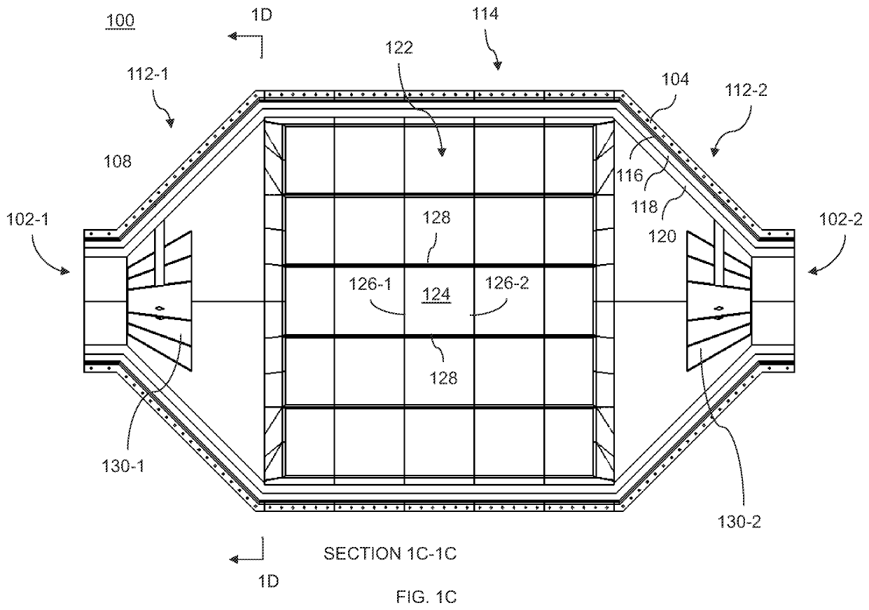

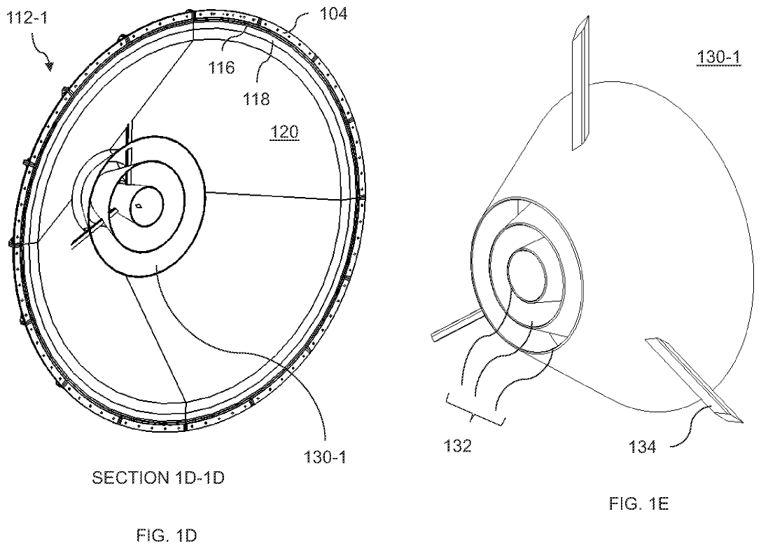

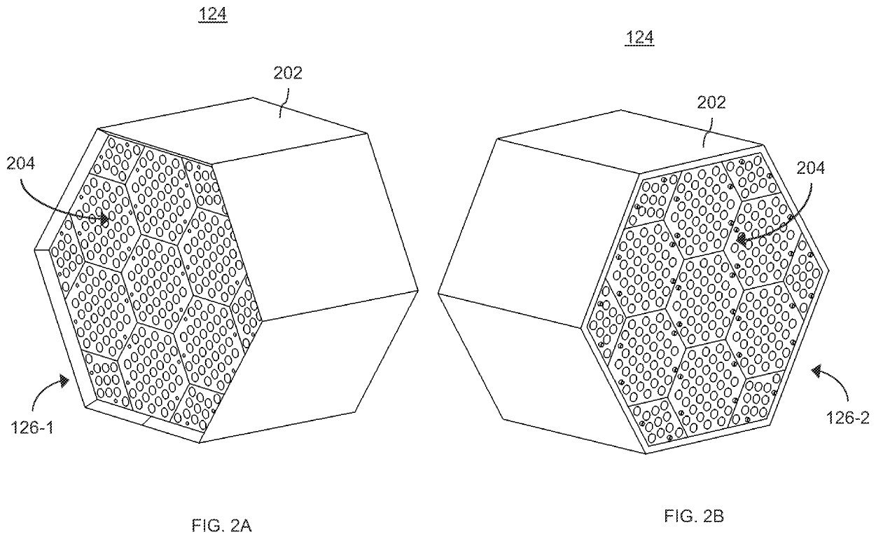

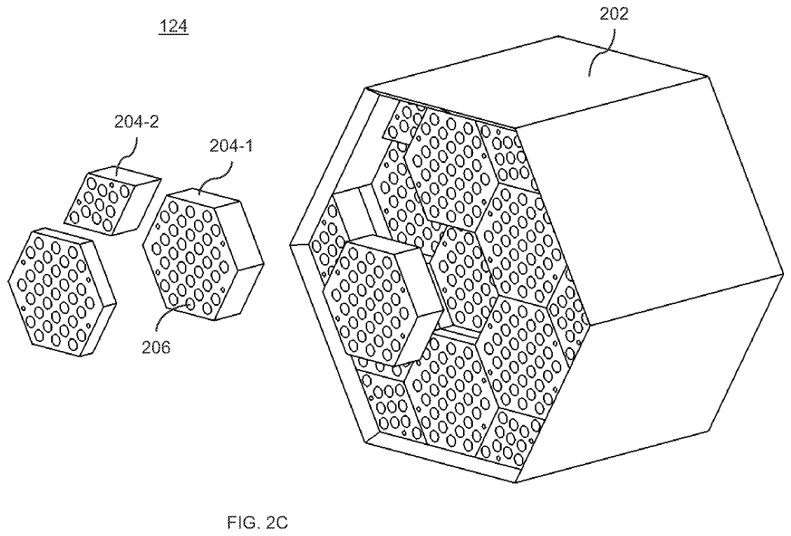

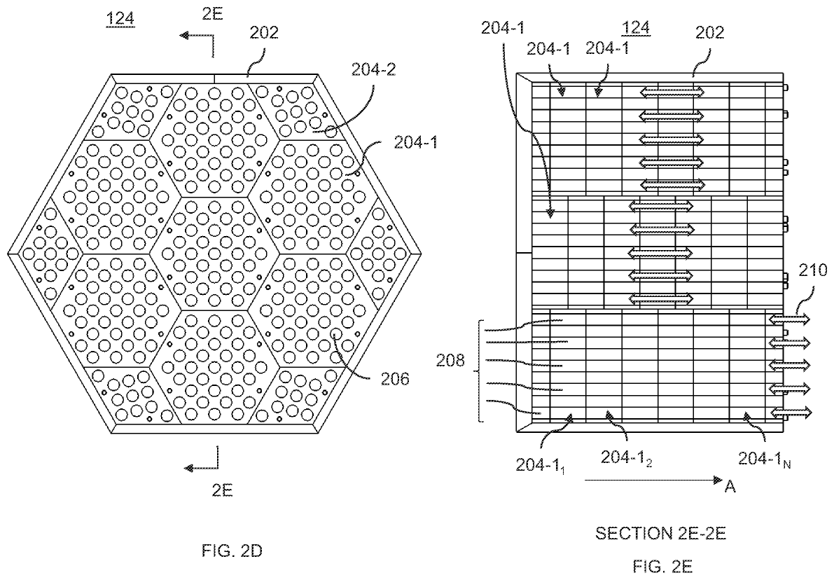

Referring next to FIGS. 1A-2E, an example heat sink vessel 100 is described, according to aspects of the present disclosure. In particular, FIG. 1A is a perspective view diagram of heat sink vessel 100; FIG. 1B is a detail view diagram of heat sink vessel 100 illustrating detail portion 1B (of FIG. 1A); FIG. 1C is a cross-sectional view diagram of heat sink vessel 100 along line 1C-1C (of FIG. 1A); FIG. 1D is a perspective view diagram of heat sink vessel 100 along line 1D-1D (of FIG. 1C); FIG. 1E is a perspective view diagram of example flow distribution and acceleration device 130 of heat sink vessel 100; FIG. 2A is a front perspective view diagram of example heat sink module 124; FIG. 2B is a back perspective view diagram of heat sink module 124; FIG. 2C is an exploded perspective view diagram of heat sink module 124; FIG. 2D is a front view diagram of heat sink module 124; and FIG. 2E is a cross-sectional view diagram of heat sink module 124 along line 2E-2E (of FIG. 2D), according to an aspect of the present disclosure.

FIG. 1A illustrates a perspective view of example heat sink vessel 100 (also referred to herein as vessel 100) as viewed from an exterior of vessel 100. FIG. 1A shows a bolted, gasketed flanged carbon steel outer shell 104, first port 102-1 and second port 102-2. In some examples, elements of outer shell 104 may be configured to allow standard shipping, common millwright assembly and a coating as needed for outside or underground placement. FIG. 1B shows a closer view of shell segments 106 and flanges 108 bolted by bolts 110 of outer shell 104 (formed, for example of carbon steel), according to an aspect of the present disclosure. In some examples flanges 108 may include gasketed flanges.

As shown in FIGS. 1A and 1B, example vessel 100 may be configured with outer shell 104 formed (for example) from carbon steel, where outer shell 104 may flanged and gasketed. This configuration practice is well-qualified and may allow vessel 100 to be shipped in segments that fit, in some examples, within a standard shipping container and/or envelope. The insulation of shell 104 (described further below with respect to FIG. 1C) may allow carbon steel to be applied, for example, by maintaining the outer temperature of carbon steel shell 104 to be less than about 100° C.

In some examples, a coating may be applied to shell 104 (e.g., formed of carbon steel). The coating may allow vessel 100 to be placed underground and/or above-ground. In some examples, the insulation of vessel 100 may also allow the stored heat to be maintained with minimal loss in a twenty four hour period. Vessel 100 of the present example may lose, in some examples, less than about 1% of the stored heat in a twenty four hour period.

As shown in FIG. 1C, vessel 100 may include first port 102-1, first fluid guidance portion 112-1, middle portion 114, second fluid guidance portion 112-2 and second port 102-2. First and second ports 102-1 and 102-2 are generally referred to as ports 102. First and second fluid guidance portions 112-1 and 112-2 are generally referred to as guidance portions 112. In some examples, vessel 100 may be configured for reversible flow of a working fluid (e.g., working fluid 210 shown in FIG. 2E). Thus, in some embodiments, during charging and discharging cycles, may reversibly form inlet port 102-1 and outlet port 102-2 (e.g., during a charging cycle) and may form outlet port 102-1 and inlet port 102-2 (e.g., during a discharging cycle). Similarly, guidance portions 112 may be reversibly form inlet guidance portion 112-1 and outlet guidance portion 112-2 (e.g., during a charging cycle) and may form outlet guidance portion 112-1 and inlet guidance portion 112-2 (e.g., during a discharging cycle). In general each of ports 102-1, 102-2 may be configured as inlet and/or outlet ports, and guidance portions 112-1, 112-2 may be configured as inlet and/or outlet guidance portions. In some examples, guidance portions 112 may include a contoured shape to aid in the guidance and distribution of a working fluid through heat sink core 122 and through vessel 100 itself.

Heat sink vessels of the present disclosure (e.g., vessel 100, vessel 300, vessel 700) may be configured to operate with one or more working fluids. In some examples, the working fluid may include an inert gas. Non-limiting examples of the working fluid may include nitrogen, argon, helium and any/or any combination thereof. It is understood that any suitable inert gas may be used in accordance with a desired thermal energy storage capacity for a desired storage period and desired application.

Vessel 100 may include outer shell 104, first insulation layer 116, second insulation layer 118 and third insulation layer 120. First, second and third insulation layers 116-120 may represent an insulation system.

Although outer shell 104 is described with respect to a material formed from carbon steel, this material represents a non-limiting example. Other examples of materials of outer shell 104 may include reinforced concrete and/or any other metal that can be formed and welded.

In a non-limiting example, first insulation layer 116 may be formed from a ceramic paper (e.g., a flexible composite of ceramic fibers), second insulation layer 118 may be formed from a fibrous alumina silicate board (or in some examples, of other suitable fibers having a larger diameter and/or greater stiffness than alumina silica fibers) and third insulation layer 120 may be formed from an alumina-silica andalusite (e.g., via casting with water as an activator) or interlinked brick. In some examples, the fibrous board (second insulation layer 118) may be configured to provide insulation, and also to carry a bearing load of third insulation 120 and heat sink core 122. In some non-limiting examples, the ceramic paper of first insulation layer 116 may include ceramic fibers of alumina, silica carbide and/or alumina silica. In some examples third insulation layer 120 may be formed of brick such as (without being limited to) alumina, silica, silica carbine and/or alumina silica. In some examples, the brick may be interlinked to fit together while allowing for expansion and contraction with usage of vessel 100.

In a non-limiting example, the insulation system inside outer shell 104 formed of carbon steel may be configured to provide a working temperature of outer shell 104 that is less than 250° C. The insulation system may be adapted to provide an outer surface temperature (with carbon steel outer shell) of less than about 80° C., allowing the overall heat loss of the heat sink to be less than 1% in a twenty-four hour period.

Middle portion 114 may include heat sink core 122. In general, heat sink core may include one or more heat sink modules 124 (where FIG. 1C illustrates plural heat sink modules 124). As shown in FIG. 1C together with FIGS. 2A and 2B, each heat sink module 124 may include a first set of opposing boundaries 126-1 and 126-2 formed by heat sink elements 204 at first and second sides of heat sink module 124. Each heat sink module 124 may also a second set of opposing boundaries 128 corresponding to containment shell 202 holding heat sink elements 204. As shown in FIGS. 2A and 2B, containment shell 202 may be configured to be hexagonally-shaped.

As shown further in FIGS. 2C-2E, heat sink elements 204 may include a plurality of hexagonally-shaped elements 204-1 and a plurality of polygonal-shaped (e.g., diamond shaped) elements 204-2. Elements 204-1 and 204-2 may be stacked and adapted to fit in containment shell 202 to form a uniform, hexagonal surface profile (e.g., as shown by boundary 126-1 in FIG. 2A) corresponding to the hexagonal profile of containment shell 202. As shown in FIGS. 2C and 2E, plural elements 204 may be stacked along longitudinal direction (as shown by arrow A in FIG. 2E) so that heat sink module 124 may include a plural number of elements 204, coupled to each other to fill containment shell 202. For example, elements 204 may be stacked (and coupled) along direction A, such as illustrated by elements 204-1₁, 204-1₂, . . . , 204-1_{N}, where N is an integer greater than or equal to 1.

Each element 204 may also include a plurality of holes 206. Each element 204 may be stacked such that holes 206 are aligned along direction A (FIG. 2E), such that holes 206 form flow passages 208 for passage of working fluid 210 through heat sink core 122 (e.g., from guidance portion 112-1 to guidance portion 112-2).

In general, elements 204 may be formed form any suitable material to retain a suitable capacity of thermal energy over a desired storage period for a desired application. Non-limiting examples of materials of heat sink elements may include one or more of high alumina (e.g., having a heat capacity of about 1.0 to about 1.1 J*kg⁻¹*K⁻¹, thermal conductivity of about 2.5 to about 2.7 W*m⁻¹*K⁻¹ and thermal expansion of about 0.8% at 1000° C.), a combination of alumina and fire clay, silicon carbide, magnesia, carbon/graphite, silica, fused silica.

In some examples, heat sink modules 124 may include plural heat sink elements 204 that may be stacked on-site. In some examples, heat sink elements 204 may be stacked in a factory, constrained with containment shell 202 (e.g. an andalusite casting or interlocking brick) and shipped to the site to be lifted into place (e.g., using alignment pins for positioning).

Referring back to FIGS. 1C and 1D, in an example embodiment, outer shell 104 may be formed from carbon steel, to form a containment vessel. The next (second, inward) layer (first insulation layer 116) may include an alumina-silicate blanket (e.g., a ceramic paper). The next (inward) layer (second insulation layer 118) nay include a fibrous silica board. The next (inward) layer (third insulation layer 120) may include an alumina-silica andalusite shell or brick arranged in an interlinked pattern. In some examples, one or more joints of vessel 100 may be sealed with a mortar (or other suitable joining material).

Middle portion 114 of vessel 100 may include ceramic heat sink 122 comprising, in this example, plural heat sink elements 204 arranged (e.g. stacked) within containment shell 202 to form heat sink modules 124. In some examples, one or more (or each) heat sink element 204 may be hexagonally-shaped.

In some examples, each hexagonally-shaped element 204 (e.g. element 204-1) is approximately a 2×2 m hexagonal. In some examples, heat sink core 122 may be configured to include small gaps (e.g., on the order of about 1 mm to about 3 mm) between elements 204, to allow for thermal movement of the heat sink core 122. In some examples, heat sink elements 204 guidance portions 112 may be configured with (e.g., andalusite-formed or brick-formed) flow directing contours.

As shown in FIGS. 1C-1E, each of guidance portions 112 may include flow distribution and acceleration device 130 (e.g., 130-1, 130-2, referred to generally as distribution device 130). Distribution device 130 may include an array of concentric cones 132 (e.g., at both ports 102 of vessel 100) and attachment members 134 for coupling of distribution device 130 to guidance portions 112. Concentric cones 132 may be configured to distribute flow of the working fluid at any of ports 112 configured as an inlet and may accelerate flow at any of ports 112 configured as an outlet. In some examples, each distribution device 130 may be formed from an austenitic steel and/or a cast ceramic (e.g. alumina and/or silica carbide). In general, distribution device 130 may be configured of any suitable material that may be robust to flow erosions and tolerate of high temperature operation (e.g., a range of about 1000° to about 1100° C. operation).

In some examples, large capacity heat sinks of the present disclosure (such as heat sink core 122) may be configured for a system that is intended to store less than about 50 MW-h of energy. In some examples, large capacity heat sinks of the present disclosure ((such as heat sink core 122) may be configured with heat sink elements 204 stacked using an andalusite or alumina silica block hexagonal frame (e.g., containment shell 202) to carry the load of the heat sink to a heat sink foundation.

In some examples, heat sinks of the present disclosure (such as heat sink core 122) may accommodate working temperatures from about 700° C. to about 1150° C. In some examples at the higher end of the operating temperature range, creep of the heat sink elements (e.g., elements 204) may become a concern. Creep may be managed by the design of the andalusite and/or brick enclosure (e.g., third insulation layer 120), in some examples, to transfer a weight of the heat sink elements to a heat sink foundation.

In some examples, the insulation system of the heat sink structure of the present disclosure (e.g., insulation layers 116-120) may use alumina-silicate materials (for example) or any other suitable material, such as one or more materials used in high temperature metallurgy or refractory applications. With reference to FIG. 1C, in some embodiments, first insulation layer 116 of the insulation system (starting from an outer diameter of the insulation system) may include a flexible ceramic paper while second insulation layer 118 may include a fibrous, formable board. These two layers (e.g., layers 116 and 118) may be configured to provide very good insulation properties and may be adjusted in thickness to provide a desired level of heat retention. These two layers (insulation layers 116 and 118) may also be configured to allow differential thermal expansion of heat sink core 122 and insulation.

In some examples, the insulation system may include a third insulation layer 120 (e.g., a shell) formed from a material such as alumina silica andalusite or brick (or any other suitable maternal), which material may be formable and may have the ability to contain and carry a load. In some examples, the material for third insulation layer 120 may be formed (e.g., in a factory) to create modules that may be fitted together in the field and thereby used to build up the assembly (i.e., vessel 100) as a modular system. In some examples, the shell (e.g., third insulation layer 120) may be designed to carry a load of the weight of heat sink core 122 to a base of heat sink core 122.

As shown in FIGS. 1D and 1E, distribution of flow of a working fluid to and from heat sink core 122 may be provided by concentric cones 132 at guidance portions 112 of vessel 100. This configuration may provide respective inlet flow distribution and outlet flow acceleration to provide a low pressure drop. In some examples, a shape of an inlet at a face of heat sink core 122 may also provide flow direction for the working fluid through heat sink modules 124 of heat sink core 122.

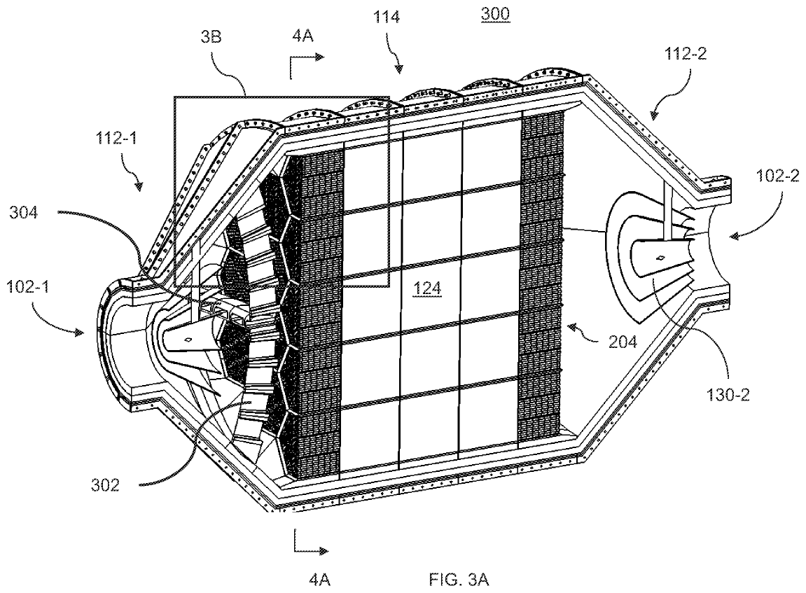

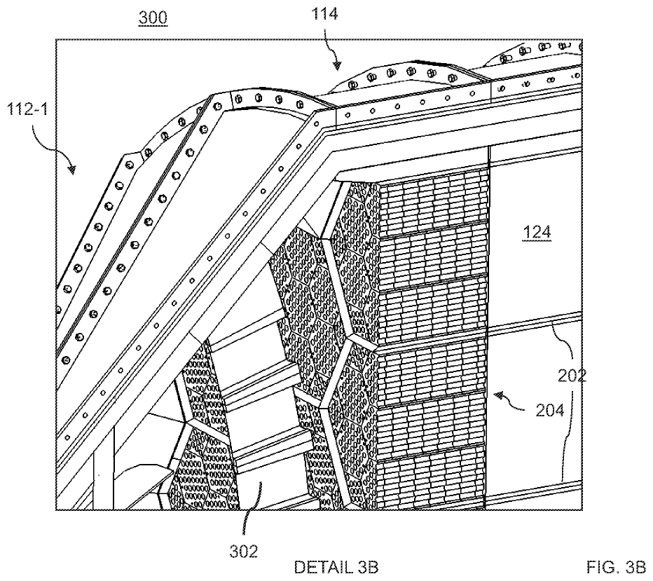

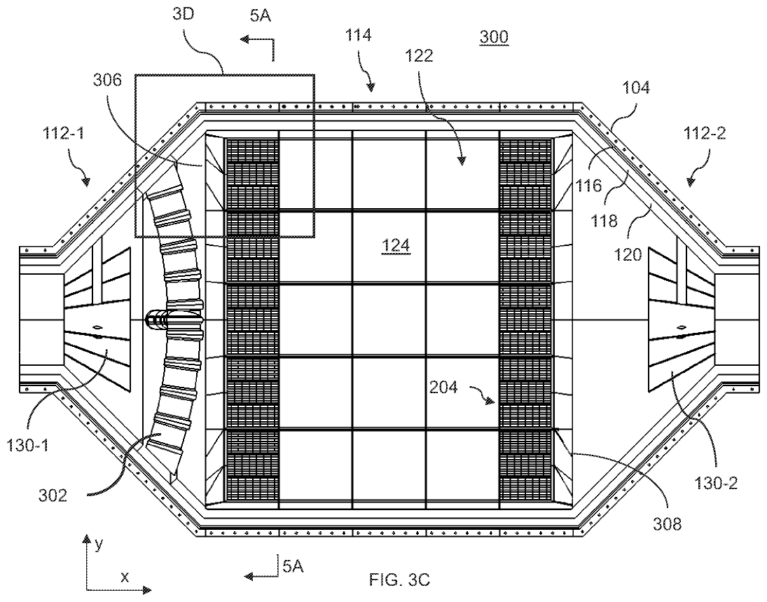

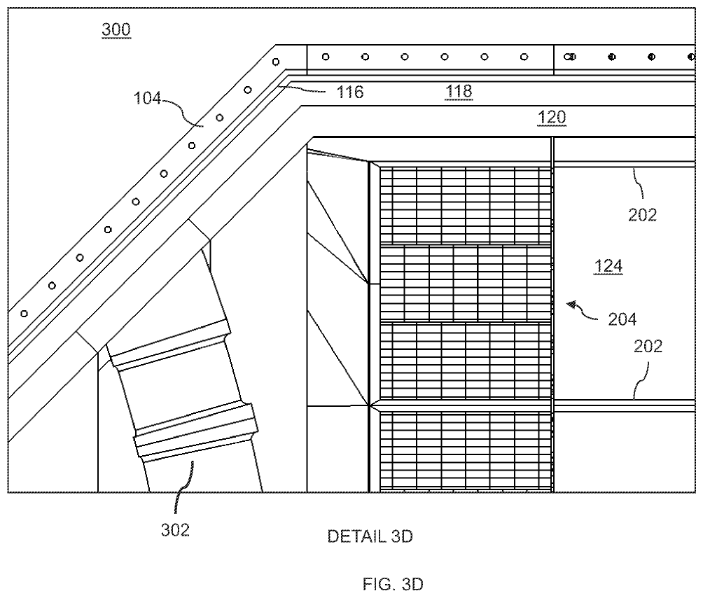

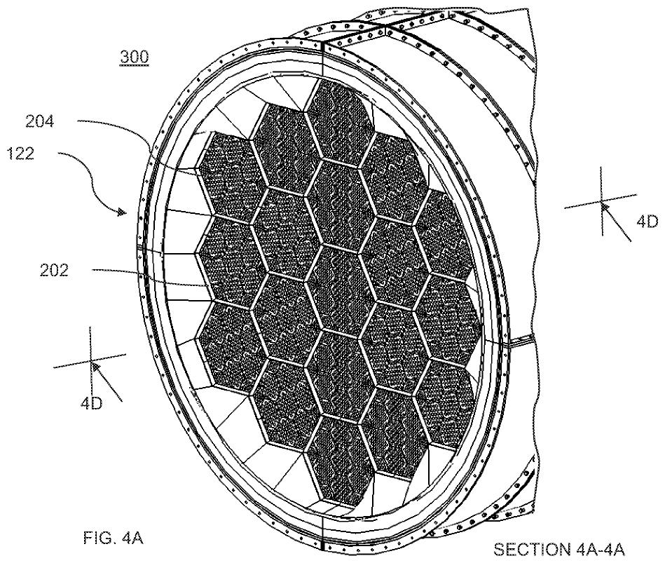

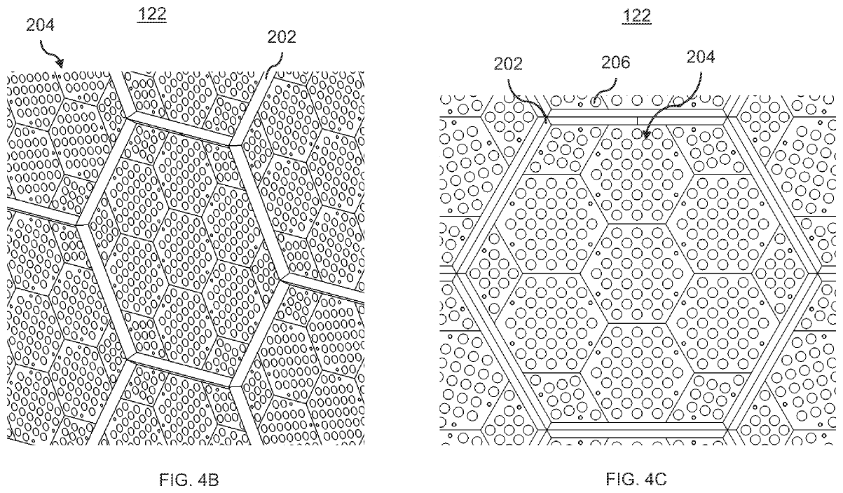

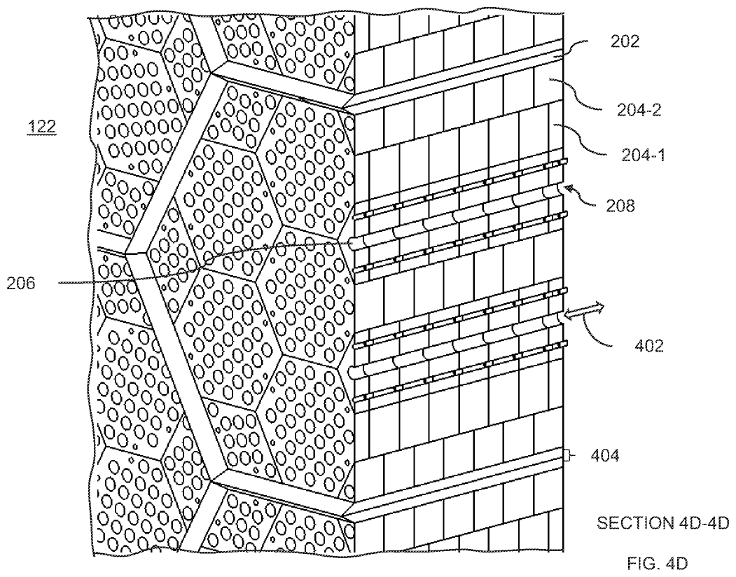

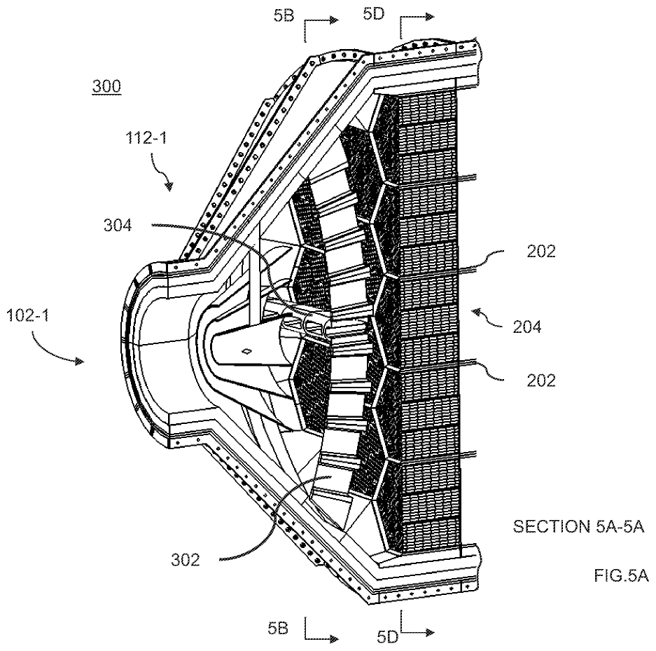

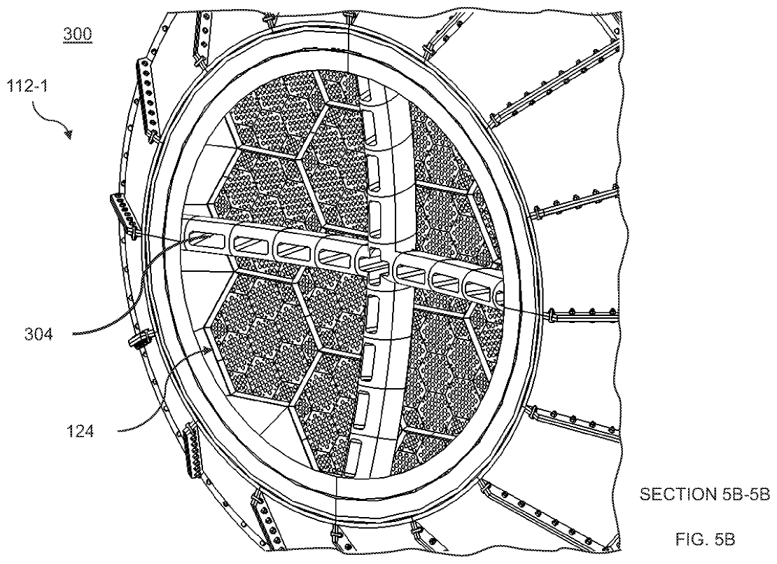

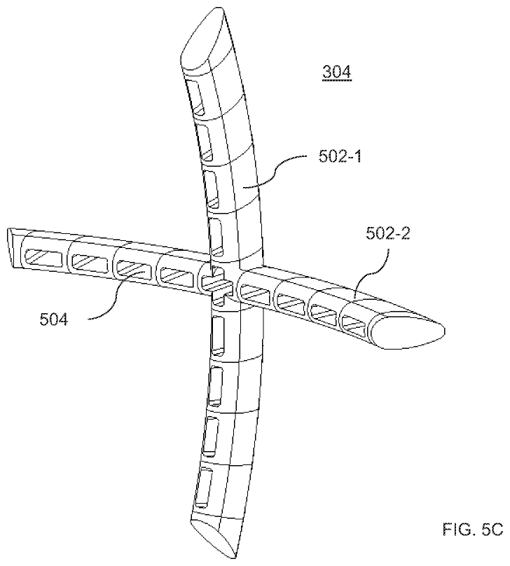

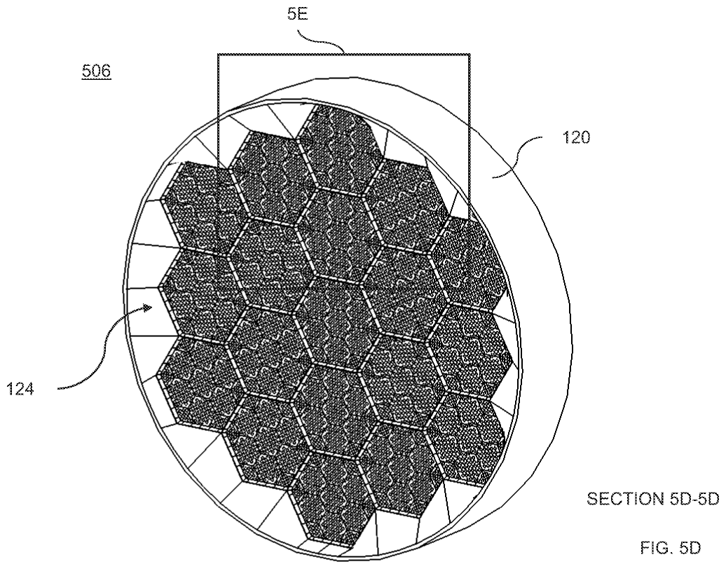

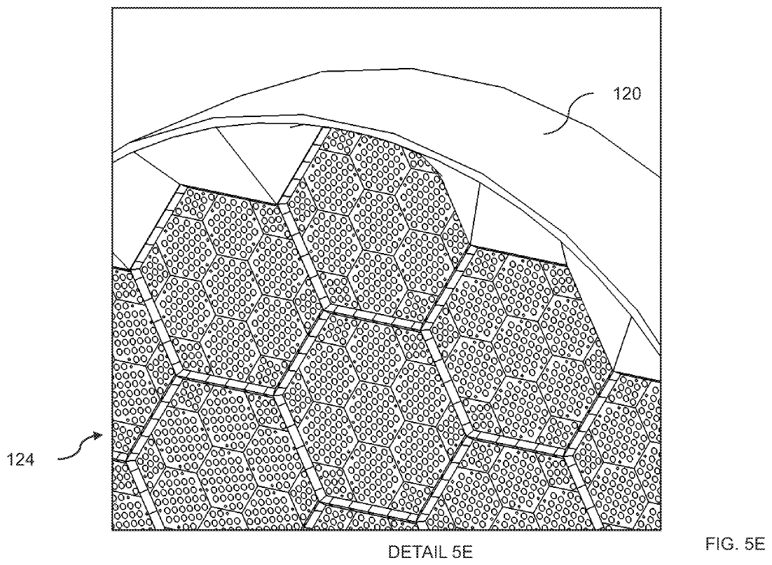

Referring next FIGS. 3A-5E, an example heat sink vessel 300 illustrating an example horizontal configuration is described (where x represents a horizontal axis and y represents a vertical axis), according to an aspect of the present disclosure. In particular, FIG. 3A is a cross-sectional perspective view diagram of heat sink vessel 300 illustrating an example horizontal configuration; FIG. 3B is a detail view diagram of heat sink vessel 300 illustrating detail portion 3B (of FIG. 3A); FIG. 3C is a cross-sectional view diagram of heat sink vessel 300; FIG. 3D is a detail view diagram of heat sink vessel 300 illustrating detail portion 3D (of FIG. 3C); FIG. 4A is a cross-sectional perspective view diagram of a portion of heat sink vessel 300 along line 4A-4A (of FIG. 3A); FIG. 4B is a perspective view diagram of a portion of heat sink core 122; FIG. 4C is a front view diagram of a portion of heat sink core 122; FIG. 4D is a cross-sectional perspective view diagram of a portion of heat sink core 122 along line 4D-4D (of FIG. 4A); FIG. 5A is a cross-sectional perspective view diagram of a portion of heat sink vessel 300 along line 5A-5A (of FIG. 3C); FIG. 5B is a cross-sectional perspective view diagram of a portion of heat sink vessel 300 along line 5B-5B (of FIG. 5A); FIG. 5C is a perspective view diagram of example arch support structure 304 of heat sink vessel 300; FIG. 5D is a perspective view diagram of a portion of heat sink vessel 300 along line 5D-5D (of FIG. 5B); and FIG. 5E is a detail view diagram of heat sink vessel 300 shown in FIG. 5D illustrating detail portion 5E (of FIG. 5D).

Heat sink vessel 300 (also referred to herein as vessel 300) is similar to vessel 100 except that vessel 300 may be adapted for a horizontal configuration (e.g., where first port 102-1, middle portion 114 and second port 102-2 extend along the horizontal axis). Vessel 300 is different from vessel 100 in that vessel 300 may include arch structure 302 and support structure 304 in first guidance portion 112-1. More specifically, arch structure 302 and support structure 304 may be positioned between first port 102-1 and first side 306 of heat sink core 122. In contrast, second side 308 of heat sink core 122 may not include an arch structure 302/support structure 304 (e.g., between second side 308 and second port 102-2). Arch structure 302 and support structure 304 may collectively be defined as a support frame. In some examples, vessel 300 may be configured for reversible flow. In general, operation of vessel 300 is similar to that of vessel 100.

FIGS. 3A-3D and 5A illustrates some of the details of heat sink modules 124 at first and second sides 306, 308 of heat sink core 122. For ease of illustration, the details of heat sink modules 124 are only shown for some of heat sink modules 124. FIGS. 4A-4D, 5D and 5E illustrate details of heat sink modules 124 including at first side 306 of heat sink core 122. FIG. 4D also illustrates the flow of working fluid 402 through flow passages 208 created by holes 206 in heat sink elements 204, for vessel 300. The details of heat sink core 122 and heat sink modules 124 are described above.

In some embodiments, for the horizontal configuration of vessel 300, small gaps (e.g., about 1 mm to about 3 mm) may be provided between heat sink modules 124 in the horizontal plane (illustrated in FIG. 4D by gap 404), to allow for differential thermal expansion. This expansion may be reasonably small, and may be managed by selecting materials (e.g., for elements 204, for containment shell 202) that have similar coefficients of thermal expansion.

In addition, in the horizontal configuration of vessel 30, first side 206 of heat sink core 122 may be supported by a support frame (formed collectively by arch structure 302 and support structure 304). In some examples, the support frame may be formed at an inlet side of vessel 300. The support frame (302, 304) may be configured to support heat sink core 122 from horizontal motion and to support heat sink modules 124 (at first side 306) during operation of vessel 300. FIGS. 3A-3D, 5A, 5B and 5C illustrates one or more of arch structure 302 and support structure 304 of the support frame. FIGS. 5B and 5C illustrate support structure 304 of the support frame. Although vessel 300 is described as including one support frame, in some examples, vessel may include two support frames, such that one support frame may support first side 306 of heat sink core 122 and a second support frame (not shown) may support second side of heat sink core 122. Although vessel 300 is described as including one support frame within first guidance portion 112-1, in some examples, the support frame may be positioned within second guidance portion 112-2.

In general, arch structure 302 may be shaped as one or more arches (or, in some examples, as a continuous structure) to form a circular shaped support structure for supporting first side 306 of heat sink core 122. Support structure 304 may include first members 502-1 in a first direction and second members 502-2 in a second (perpendicular) direction. Support structure 304 may also include holes 504 for passing a working fluid therethrough. Members 502-1 and 502-2 may be coupled to arch structure 302. In some examples, arch structure 302 and support structure 304 may be formed of alumina silica andalusite and/or brick.

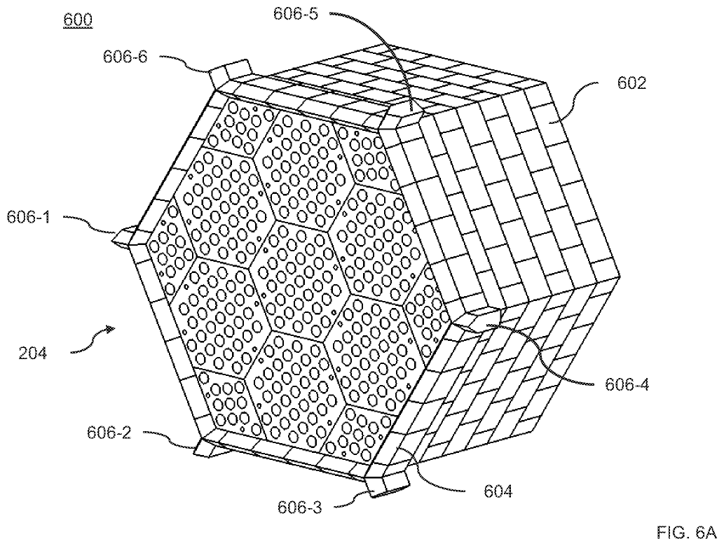

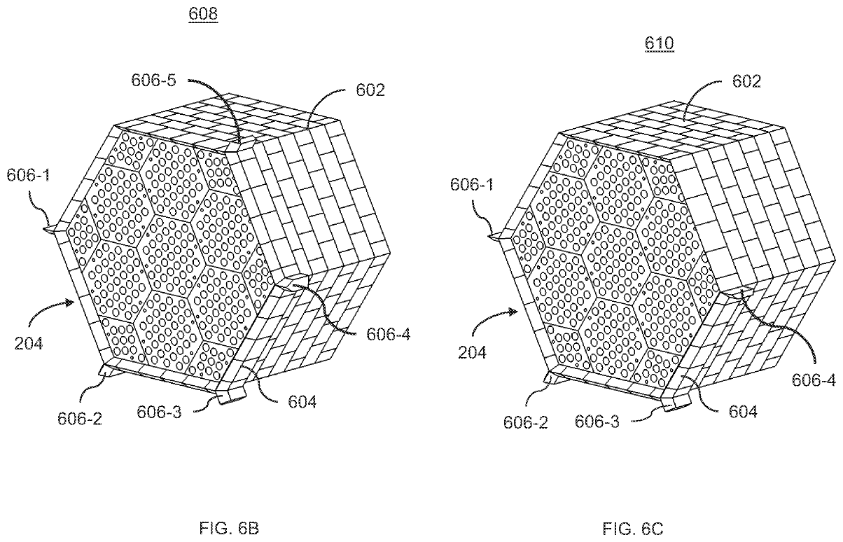

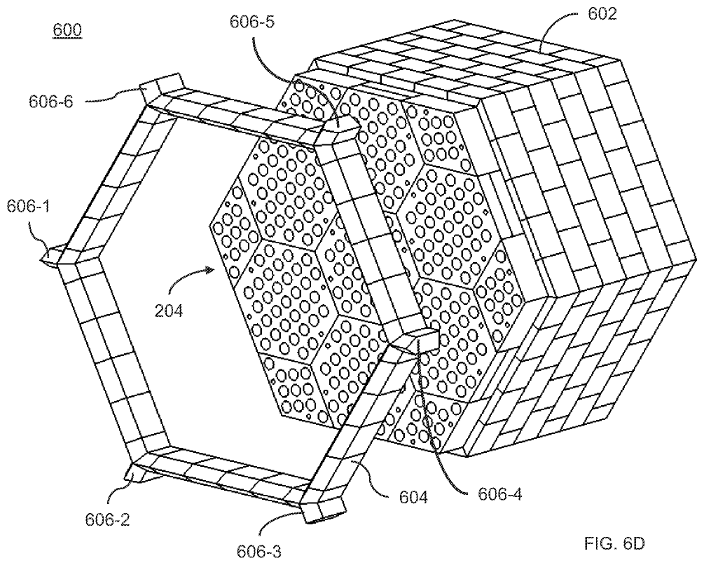

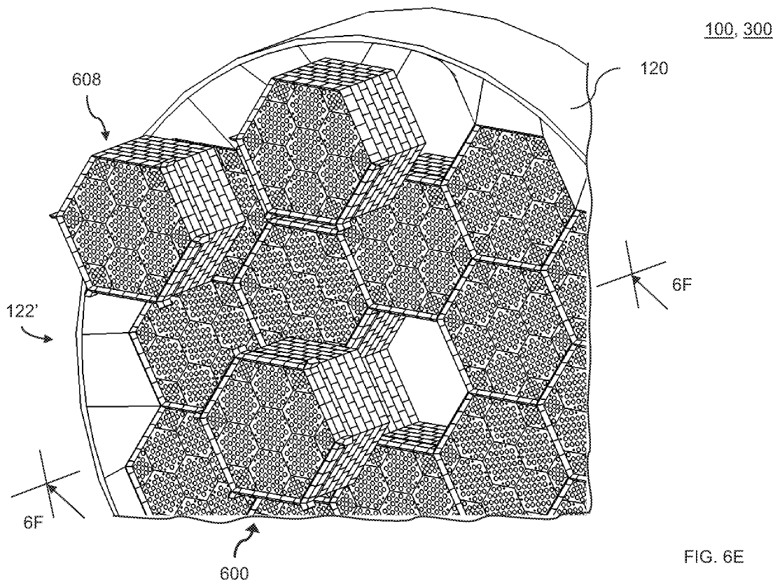

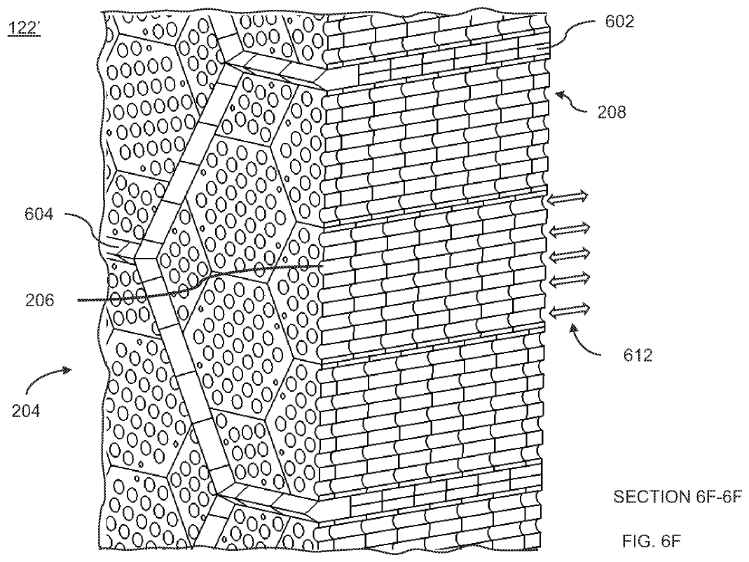

Referring next to FIGS. 6A-6F, examples of a heat sink vessel having brick-lined heat sink modules is described, according to aspects of the present disclosure. In particular, FIGS. 6A, 6B and 6C are perspective view diagrams of example respective heat sink modules 600, 608 and 610; FIG. 6D is an exploded perspective view diagram of example heat sink module 600; FIG. 6E is an exploded perspective view diagram of a portion of a heat sink vessel (e.g., vessel 100, vessel 300) illustrating a configuration of heat sink modules 124′ in heat sink core 122′; and FIG. 6F is a cross-sectional perspective view diagram of a portion of heat sink core 122′ along line 6F-6F (of FIG. 6E).

In general heat sink module 600 is similar to heat sink module 124 shown in FIGS. 2A-2D, except that heat sink module 600 includes containment shell 602 and collar 604 instead of containment shell 202 to enclose heat sink elements 204. Each of containment shell 602 and collar 604 may be configured of interlocking brick. Collar 604 may include one or more protrusions 606 for coupling of multiple heat sink modules together (e.g., as shown best in FIG. 6E). FIGS. 6A-6C illustrate examples of heat sink modules 600, 608 and 610 having collars 604 with different numbers of protrusions. For example, heat sink module 600 includes collar 604 with six protrusions 606 (e.g., 606-1, 606-2, 606-3, 606-4, 606-5 and 606-6). Heat sink module 608 includes collar 604 with five protrusions 606 (e.g., 606-1, 606-2, 606-3, 606-4 and 606-5).). Heat sink module 610 includes collar 604 with four protrusions 606 (e.g., 606-1, 606-2, 606-3 and 606-4). In some examples, heat sink core 122′ may be formed of heat sink modules 600, heat sink modules 608, heat sink modules 610 and/or one or more combinations thereof. For example, FIG. 6E illustrates heat sink core 122′ have both heat sink modules 600 and heat sink modules 608). In some examples, protrusions 606 may be used to create gaps between heat sink modules 600 (608 and/or 610).

Heat sink core 122′ is the same as heat sink core 122 except that heat sink core 122′ includes brick-lined heat sink modules 600 (and/or one or more of modules 608 and 610). In some examples, one or more of vessels 100 and 300 may be formed with heat sink core 122′ (instead of heat sink core 122′) such that heat sink core may include brick-lined heat sink modules 600 (608 and/or 610).

FIG. 6F illustrates the flow of working fluid 612 through flow passages 208 created by holes 206 in heat sink elements 204 of heat sink modules 600 forming heat sink core 122′. The details of heat sink core 122 and heat sink modules 124 are described above and are similar for heat sink modules 600 and heat sink core 122′.

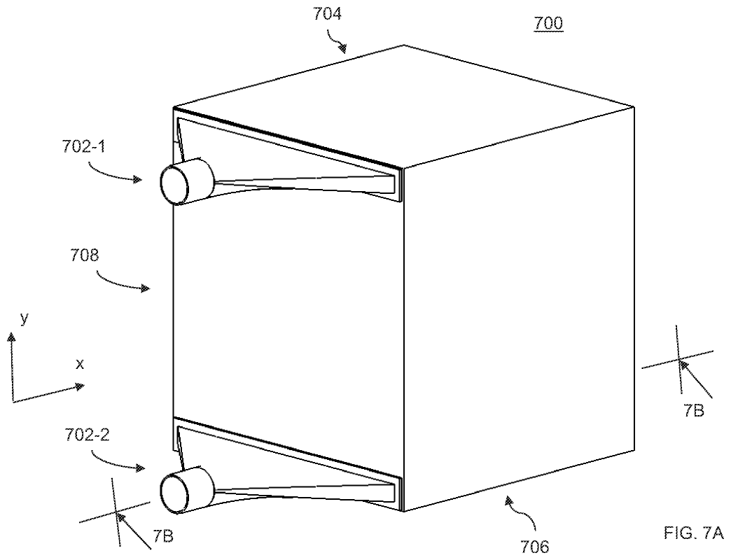

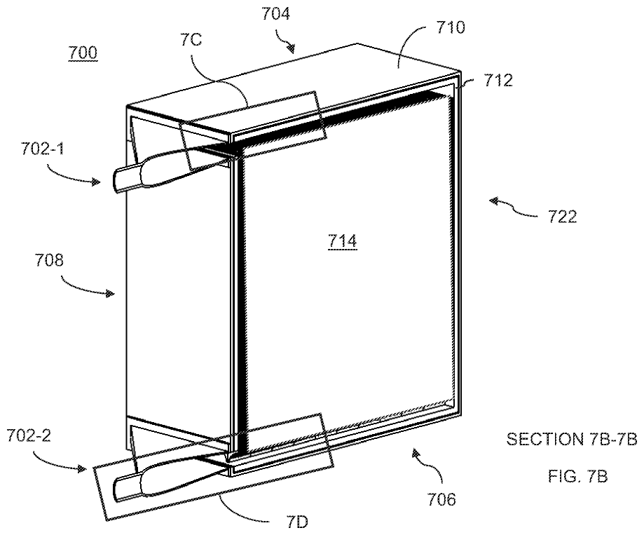

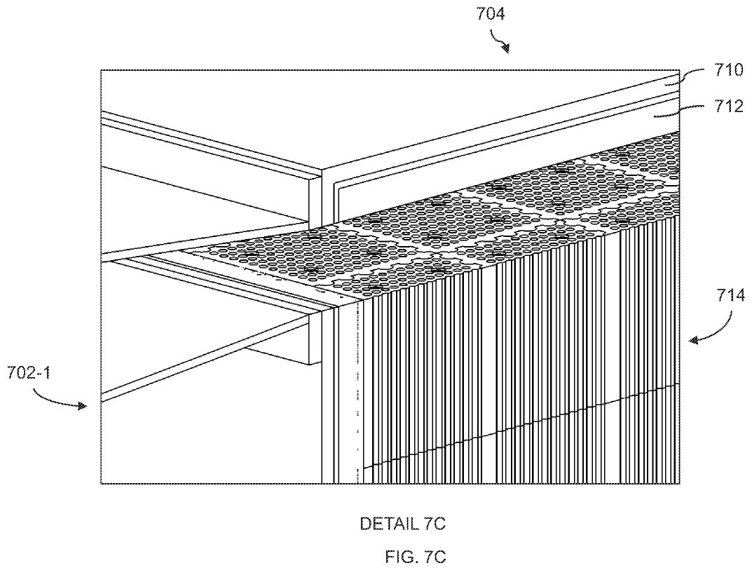

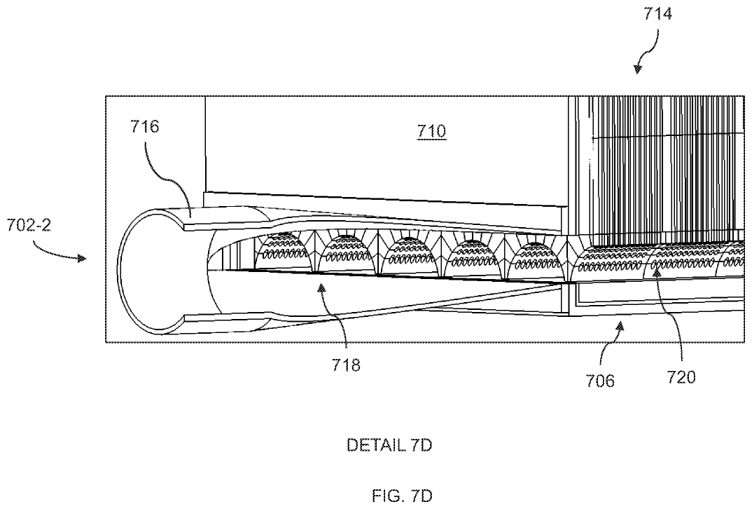

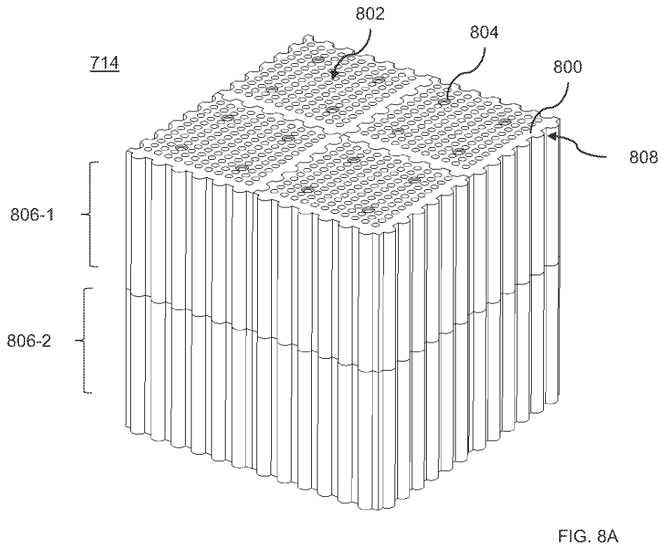

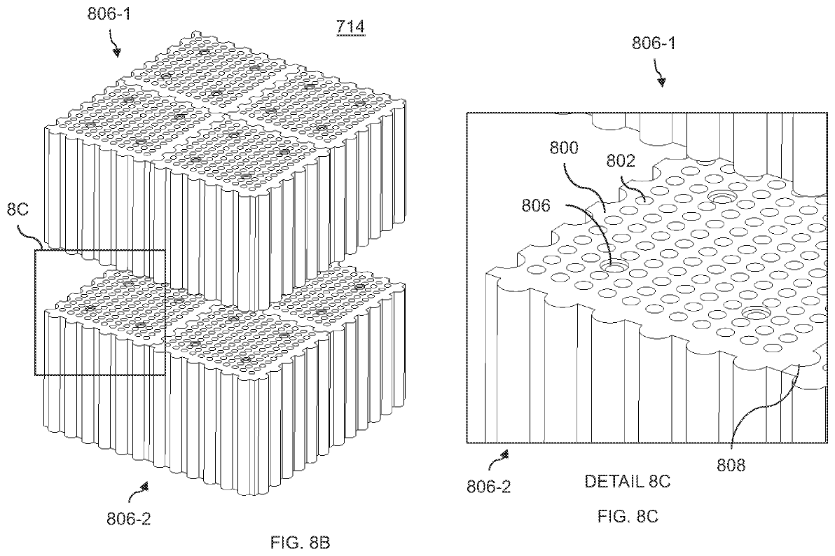

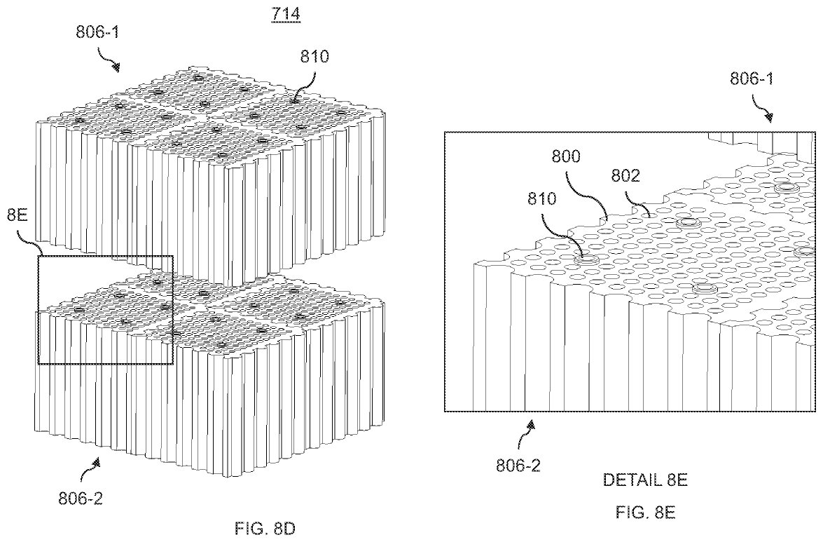

Referring next FIGS. 7A-8E, an example heat sink vessel 700 illustrating an example vertical configuration is described (where x represents a horizontal axis and y represents a vertical axis), according to an aspect of the present disclosure. In particular, FIG. 7A is a perspective view diagram of example heat sink vessel 700 illustrating a vertical configuration; FIG. 7B is a cross-sectional perspective view diagram of heat sink vessel 700 along line 7B-7B (of FIG. 7A); FIG. 7C is a detail view diagram of heat sink vessel 700 illustrating detail view 7C (of FIG. 7B); FIG. 7D is a detail view diagram of heat sink vessel 700 illustrating detail view 7D (of FIG. 7B); FIG. 8A is a perspective view diagram of a portion of heat sink core 712 of heat sink vessel 700; FIG. 8B is an exploded perspective view of heat sink core portion 712; FIG. 8C is a detail view diagram of heat sink core portion 712 illustrating detail view 8C (of FIG. 8B); FIG. 8D is an exploded perspective view of heat sink core portion 712; and FIG. 8E is a detail view diagram of heat sink core portion 712 illustrating detail view 8E (of FIG. 8D).

Heat sink vessel 700 (also referred to herein as vessel 700) is similar to vessel 100 except that vessel 700 may be adapted for a vertical configuration (e.g., where first guidance portion 702-1, middle portion 722 and second guidance portion 702-2 extend along the vertical axis). Vessel 700 is different from vessel 100 in that vessel 700 may include arch support structure 718 at bottom portion 706. Vessel 700 is also different from vessel 100 in that a shape of vessel 700 is a cuboid whereas vessel 100 is generally a cylinder. Vessel 700 is also different in a shape of guidance portions 702 as compared to guidance portions 112. Finally a structure of heat sink modules 800 of heat sink core 714 is different from heat sink modules 124 and 600. In general, operation of vessel 700 is similar to that of vessel 100 (and vessel 300). In some examples, vessel 700 may be configured for reversible flow. Vessel 700 is also different from vessel 100 in that vessel may not include distribution device(s) 130.

Vessel 700 may include first and second guidance portions 702-1 and 702-2 (referred to generally as guidance portions 702) and middle portion 722. Guidance portions 702-1 and 702-2 are similar to guidance portions 112 described above. Middle portion 702 may include top portion 704, bottom portion 706 and sides 708 having outer shell 710 and insulation system 712. Outer shell 710 is similar to outer shell 104 and may be formed of similar materials (such as carbon steel). Insulation system 712 may include insulation layers 116-120, as described above. Middle portion 702 may contain heat sink core 714.

As shown in FIG. 7D, heat sink core 714 may be supported by arch support structure 718 at bottom portion 706 of vessel 700. FIG. 7D also illustrates that arch support structure may include a plurality of holes 720 for passing a working fluid therethrough. FIG. 7D also illustrates port 716 of guidance portion 702-2. Guidance portion 702-1 may include a similar port 716 for flow of the working fluid into and/or out of vessel 700. Thus, in the vertical orientation, a lower face of the heat sink core 714 may be supported by arch support structure 718 that may be positioned immediately above the flow distributor (e.g., a part of guidance portion 702-2. Arch support structure 718 may also support heat sink core 714 from horizontal motion as well as a weight of heat sink core 714. In a non-limiting example, arch support structure 718 may be supported by outer shell 710 formed of carbon steel, and arch support structure 718 may be fabricated from alumina silica brick. The configuration of vessel 700 has the advantage of allowing thermal expansion of heat sink core 714 without a need for gaps among heat sink modules 800. In some example, a height of heat sink core 714 may be constrained by a carrying load of arch support structure 718.

As shown in FIGS. 8A-8E, heat sink core 714 may include heat sink modules 800 arranged in multiple arrays 806 (e.g., array 806-1 and array 806-2). Each heat sink module 800 may include plural holes 802, similar to heat sink module 124 (as well as 600, 608 and 610). Similar to heat sink module 124, holes 802 may form flow passages for passing a working fluid therethrough. In contrast to heat sink module 124, heat sink module 800 may be formed of a continuous (single) material having plural holes 802 bored therethrough (in contrast to multiple heat sink elements 204 encased in containment shell 202). Each heat sink module 800 may be stacked on each other such that holes 802 are aligned across arrays 806, to form vertical flow passageways (e.g., see FIG. 7C).

Each heat sink module 800 may include patterned edge 808 (e.g., ridges and grooves). In this manner two or more heat sink modules 800 may coupled to each other (e.g., in an array) and interlocked via the ridges and grooves in patterned edge 808 (for example, see FIGS. 8A and 8C).

Each heat sink module 800 may include one or more recesses 804 on one side and one more corresponding guide pins 810 on an opposite side (see FIGS. 8C and 8E). Recesses 804 and guide pins 810 may be utilized to align and stack heat sink modules 800 into arrays 806.

In some examples, each heat sink module 800 may be lifted into place by the use of a tool that connects to an open face (of the module) by a set of alumina pins (e.g., guide pins 810). The heat sink module 800 may then located to the next module or the shell by a second set of alumina pins (e.g., guide pins 810). The configuration of vessel 700 has an advantage of forming a continuous heat sink core (via single-structured heat sink modules 800), and also of accommodating thermal expansion of the core.

While the present disclosure has been discussed in terms of certain embodiments, it should be appreciated that the present disclosure is not so limited. The embodiments are explained herein by way of example, and there are numerous modifications, variations and other embodiments that may be employed that would still be within the scope of the present disclosure.

1. A heat sink vessel comprising:
a body defining an interior volume, the body configured to circulate a working fluid therethrough, the body comprising:
a first guidance portion coupled to a first port;
a second guidance portion coupled to a second port; and
a middle portion coupled to each of the first guidance portion and the second guidance portion, the middle portion comprising a heat sink core, the heat sink core formed from a plurality of heat sink modules collectively arranged and coupled together to form a plurality of flow passages through the heat sink core, the heat sink vessel configured to circulate the working fluid through the plurality of flow passages of the heat sink core via the first port and the second port.

2. The heat sink vessel of claim 1, wherein at least one of the first guidance portion and the second guidance portion comprises a contour to at least one of guide and distribute the working fluid through the heat sink core.

3. The heat sink vessel of claim 1, wherein the heat sink vessel is operable for reversible flow of the working fluid through the heat sink core over one or more charging and discharging cycles.

4. The heat sink vessel of claim 1, further comprising at least one distribution device disposed within one or more of the first guidance portion and the second guidance portion, the at least one distribution device configured to at least one of distribute the working fluid into the heat sink vessel and accelerate the working fluid exiting the heat sink vessel.

5. The heat sink vessel of claim 4, wherein the at least one distribution device comprise a concentric cone structure.

6. The heat sink vessel of claim 1, further comprising an outer shell configured to encase the body.

7. The heat sink vessel of claim 6, wherein the outer shell is formed from a plurality of shell segments formed of carbon steel, the plurality of shell segments adapted to be flanged and gasketed together.

8. The heat sink vessel of claim 6, further comprising an insulation system between the outer shell and the heat sink core.

9. The heat sink vessel of claim 8, wherein the insulation system comprises at first insulation layer, the first insulation formed from a material comprising at least one of alumina-silica andalusite and brick.

10. The heat sink vessel of claim 9, wherein the insulation system further comprises a ceramic paper and a fibrous board.

11. The heat sink vessel of claim 1, wherein each of the plurality of heat sink modules comprises:
a containment shell; and
a plurality of heat sink elements, each element of the plurality of heat sink elements comprising a plurality of holes,
wherein the plurality of heat sink elements are configured to be arranged within the containment shell such that the plurality of holes of each element are aligned to form at least a portion of the plurality of the flow passages.

12. The heat sink vessel of claim 11, wherein the containment shell is formed from a material comprising at least one of one andalusite and brick.

13. The heat sink vessel of claim 11, wherein:
each of the plurality of heat sink modules comprise a hexagonal shape, and
one or more of the plurality of heat sink elements comprise a hexagonal shape.

14. The heat sink vessel of claim 11, wherein each of the plurality of heat sink elements is formed from a material comprising at least one of high alumina, alumina, fire clay, silicon carbide, magnesia, carbon, silicon and fused silica.

15. The heat sink vessel of claim 1, wherein each of the plurality of heat sink modules comprises:
a heat sink element forming a single uniform structure, the heat sink element comprising a plurality of holes that form at least a portion of the plurality of the flow passages.

16. The heat sink vessel of claim 15, wherein the heat sink element further comprises:
a patterned edge configured to interface with a further heat sink element,
at least one recess in a first surface of the heat sink element, and
at least one guide pin in a second surface of the heat sink element.

17. The heat sink vessel of claim 1, further comprising at least one heat sink support structure disposed in at least one of the first guidance portion and the second guidance portion.

18. The heat sink vessel of claim 17, wherein the at least one heat sink support structure is configured to support the heat sink core in one of a vertical configuration and a horizontal configuration of the heat sink vessel.

19. The heat sink vessel of claim 1, wherein one or more components of heat sink vessel are adapted for modular assembly.

20. A heat sink vessel adapted for a horizontal configuration comprising:
a body defining an interior volume, the body configured to circulate a working fluid therethrough, the body comprising:
a first guidance portion coupled to a first port;
a second guidance portion coupled to a second port;
a middle portion coupled to each of the first guidance portion and the second guidance portion, the middle portion comprising a heat sink core, the heat sink core formed from a plurality of heat sink modules collectively arranged and coupled together to form a plurality of flow passages through the heat sink core, the heat sink vessel configured to circulate the working fluid through the plurality of flow passages of the heat sink core via the first port and the second port, the plurality of flow passages arranged to extend in a horizontal configuration; and
at least one support structure disposed in at least one of the first guidance portion and the second guidance portion, the at least one support structure configured to restrain the heat sink core in the horizontal configuration.

21. The heat sink vessel of claim 20, further comprising at least one distribution device disposed within one or more of the first guidance portion and the second guidance portion, the at least one distribution device configured to at least one of distribute the working fluid into the heat sink vessel and accelerate the working fluid exiting the heat sink vessel.

22. The heat sink vessel of claim 20, wherein the plurality of heat sink modules are coupled together such that a predetermined gap is formed between adjacent ones of the heat sink modules in a horizontal direction.

23. The heat sink vessel of claim 20, wherein each of the plurality of heat sink modules comprises:
a containment shell; and
a plurality of heat sink elements, each element of the plurality of heat sink elements comprising a plurality of holes,
wherein the plurality of heat sink elements are configured to be arranged within the containment shell such that the plurality of holes of each element are aligned to form at least a portion of the plurality of the flow passages.

24. The heat sink vessel of claim 23, wherein:
the containment shell is formed from a material comprising at least one of one andalusite and brick, and
each of the plurality of heat sink elements is formed from a material comprising at least one of high alumina, alumina, fire clay, silicon carbide, magnesia, carbon, silicon and fused silica.

25. A heat sink vessel adapted for a vertical configuration comprising:
a body defining an interior volume, the body configured to circulate a working fluid therethrough, the body comprising:
a first guidance portion coupled to a first port at a bottom portion of the body;
a second guidance portion coupled to a second port at an upper portion of the body;
a middle portion coupled to each of the first guidance portion and the second guidance portion, the middle portion comprising a heat sink core, the heat sink core formed from a plurality of heat sink modules arranged in at least one array and coupled together to form a plurality of flow passages through the heat sink core, the heat sink vessel configured to circulate the working fluid through the plurality of flow passages of the heat sink core via the first port and the second port, the plurality of flow passages arranged to extend in a vertical configuration; and
a support structure disposed in the bottom portion of the body and configured to support the heat sink core.

26. The heat sink vessel of claim 25, wherein the at least one array comprises two or more arrays configured to be coupled together along a vertical direction.

27. The heat sink vessel of claim 25, wherein each of the plurality of heat sink modules comprises:
a heat sink element forming a single uniform structure, the heat sink element comprising a plurality of holes that form at least a portion of the plurality of the flow passages.

28. The heat sink vessel of claim 27, wherein the heat sink element further comprises a patterned edge configured to interface with a further heat sink element among the at least one array.

29. The heat sink vessel of claim 27, wherein the heat sink element further comprises:
at least one recess in a first surface of the heat sink element, and
at least one guide pin in a second surface of the heat sink element.

30. The heat sink vessel of claim 25, wherein the support structure comprises a plurality of arches configured to direct the working fluid within the first guidance portion.
